(19) United States
(12) Patent Application Publication
(10) Pub. No.: US 2005/0129472 A1
(43) Pub. Date: Jun. 16, 2005

(54) Guide for drill

(76) Inventors: Hsu Hsiu-Kwei Liu, Feng Yuan City (TW); Ming-Hsiang Chiu, Chia Yi City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/736,035

(22) Filed: Dec. 15, 2003

(51) Int. Cl. B23B 49/02

(52) U.S. Cl. 408/115 R

(57) ABSTRACT

A guide is provided for guiding a first drill and a second drill while boring a door with holes for receiving a lock. The guide includes a first element, a second element, a third element, a first threaded bolt and a second threaded bolt. The first element guides the first drill and abuts a first face of the door. The second element guides the first drill and abuts a second face of the door. The third element abuts a side of the door. The first threaded bolt is connected between the first element and the third element so that the first element is movable on the first face of the door. The first threaded bolt is operable for driving the first element against the first face of the door. The second threaded bolt is connected between the second element and the third element so that the second element is movable on the second face of the door. The second threaded bolt is operable for driving the second element against the second face of the door.

### FIELD OF INVENTION

The present invention relates to drills and, more particularly, to a guide for drills while boring a door with holes for receiving a lock.

### BACKGROUND OF INVENTION

Referring to FIG. 8, there is shown a conventional guide 60 for drills (not shown) while boring a door with holes for a lock (not shown). The conventional guide 60 includes a first portion 62 and a second portion 64 extending perpendicular to the first portion 62. A hole 66 is defined in the first portion 62. On the first portion 62 extends a rim 68 around the hole 66. A hole 70 is defined in the second portion 64. On the second portion 64 extends a rim 72 around the hole 70. Two holes 74 are defined in the second portion 64. Referring to FIG. 9, a door D1 is shown. The door D1 includes a front face, a rear face and a side between the front and rear faces. The first portion 62 is put against the front face of the door D1. The second portion 64 is put against the side of the door D1. Two screws 76 are driven into the side of the door D1 through the holes 74 in order to secure the guide 60 to the door D1. A first drill (not shown) can be put into the hole 66 and guided by means of the rim 68. The first drill can be driven through the door D1 from the front face to the rear face in order to bore a first hole (not shown) in the door D1. A second drill (not shown) can be put into the hole 70 and guided by means of the rim 72. The second drill can be driven into the door D1 from the side in order to bore a second hole (not shown) in the door D1. The first hole is communicated with the second hole. A lock (not shown) can be put in the first hole, and a tongue of the lock can be put in the second hole. There is a need to bore the first hole in a different position. This need cannot be satisfied due to the first portion 62 made of a fixed size. Furthermore, it is required that the second hole be located in the middle of the side of the door D1. This requirement cannot be fulfilled if the guide 60 is used for another door D2 of a different thickness shown in FIG. 10 due to the second portion 64 made of a fixed size. Moreover, after removal of the guide 60 from the door D1 or D2, two holes are left in the side because of the screws 74, and this is not desired.

The present invention is therefore intended to obviate or at least alleviate the problems encountered in prior art.

### SUMMARY OF INVENTION

It is an objective of the present invention to provide drills with a guide making it possible to bore a door with a hole at various distances from a side of the door.

It is another objective of the present invention to provide drills with a guide ensuring that a hole be bored in the middle of a side of a door regardless of the thickness of the door.

According to the present invention, a guide is provided for guiding a first drill and a second drill while boring a door with holes for receiving a lock. The guide includes a first element, a second element, a third element, a first threaded bolt and a second threaded bolt. The first element guides the first drill and abuts a first face of the door. The second element guides the first drill and abuts a second face of the door. The third element abuts a side of the door. The first threaded bolt is connected between the first element and the third element so that the first element is movable on the first face of the door. The first threaded bolt is operable for driving the first element against the first face of the door. The second threaded bolt is connected between the second element and the third element so that the second element is movable on the second face of the door. The second threaded bolt is operable for driving the second element against the second face of the door.

Other objects, advantages and novel features of the invention will become more apparent from the following detailed description in conjunction with the attached drawings.

### BRIEF DESCRIPTION OF DRAWINGS

The present invention will be described through detailed illustration of two embodiments referring to the drawings.

FIG. 1 is a perspective view of a guide for drills according to a first embodiment of the present invention.

FIG. 2 is an exploded view of the guide of FIG. 1.

FIG. 3 is a cross-sectional view of the guide of FIG. 1 used for a door.

FIG. 4 is similar to FIG. 3 but shows the guide in a different position for boring the door with a hole at another distance from a side of the door.

FIG. 5 is similar to FIG. 3 but shows the guide in a different position for boring the door with a hole in a position biased from the middle of a side of the door.

FIG. 6 is similar to FIG. 3 but shows the guide used for a thicker door.

FIG. 7 is an exploded view of a guide for drills according to a second embodiment of the present invention.

FIG. 8 is a perspective view of a conventional guide for drills.

FIG. 9 is a cross-sectional view of the conventional guide of FIG. 8 used for a door.

FIG. 10 is similar to FIG. 9 but shows the conventional guide used for a thicker door.

### DETAILED DESCRIPTION OF EMBODIMENTS

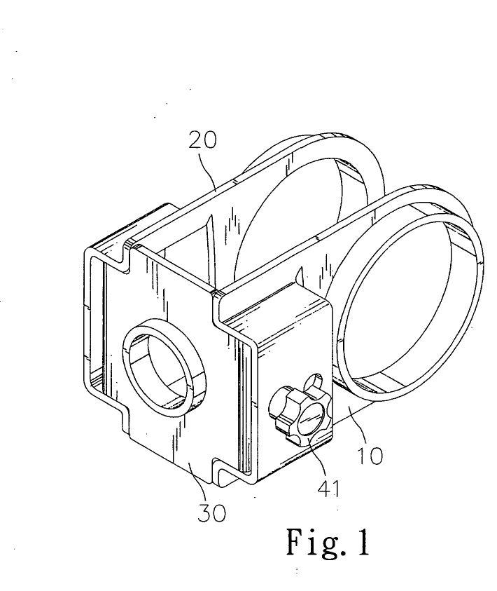

Referring to FIG. 1, according to a first embodiment of the present invention, a guide is provided for drills (not shown) while boring a door with holes for receiving a lock. The guide includes a first element 10, a second element 20 and a third element 30.

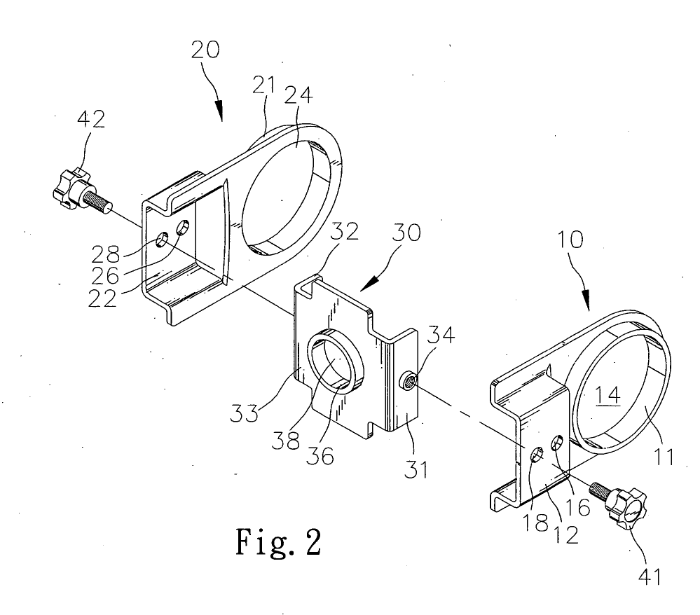

Referring to FIG. 2, the first element 10 includes a rim 11 formed on a first portion thereof and a bracket 12 raised from a second portion thereof. In the first portion of the first element 10 is defined a window 14 around which the rim 11 extends. Two holes 16 and 18 are defined in the bracket 12.

The second element 20 includes a rim 21 formed on a first portion thereof and a bracket 22 raised from a second portion thereof. In the first portion of the second element 20 is defined a window 24 around which the rim 21 extends. Two holes 26 and 28 are defined in the bracket 22.

The third element 30 includes a first portion 31, a second portion 32 and a third portion 33 formed between the first portion 31 and the second portion 32. A threaded hole 34 is defined in the first portion 31 of the third element 30. A threaded hole 35 is defined in the second portion 32 of the third element 30. A rim 36 is formed on the third portion 33 of the third element 30. In the third portion 33 of the third element 30 is defined a window 38 around which the rim 36 extends.

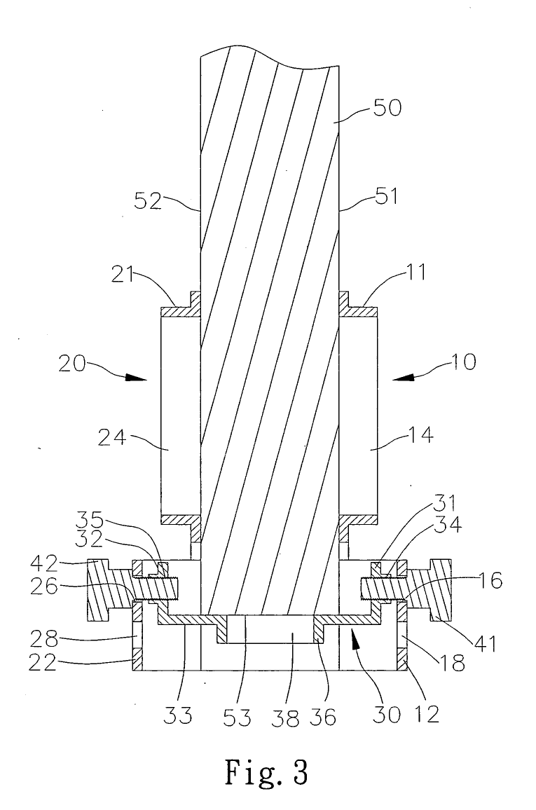

Referring to FIG. 3, a door 50 is shown. The door 50 includes a first face 51, a second face 52 and a side 53 between the first face 51 and the second face 52.

The first element 10 is put against the first face 51 of the door 50. The second element 20 is put against the second face 52 of the door 50. The third portion 33 of the third element 30 is put against the side 53 of the door 50. The first portion 31 of the third element 30 is covered via the bracket 12. The second portion 32 of the third element 30 is covered via the bracket 22. A first threaded bolt 41 is driven into the threaded hole 34 through the hole 16. A second threaded bolt 42 is driven into the threaded hole 35 through the hole 26. Thus, the guide is secured to the door 50.

In order to bore a first hole (not shown) in the door 50, a first drill (not shown) is put into the window 14 or 24, guided via the rim 11 or 21. The first drill is driven from the first face 51 to the second face 52 or from the second face 52 to the first face 51. In order to bore a second hole (not shown) in the door 50, a second drill (not shown) is put into the window 38, guided via the rim 36. The second drill is driven into the door 50 from the side 53. The first hole is communicated with the second hole. A lock (not shown) can be put in the first hole, and a tongue of the lock can be put in the second hole.

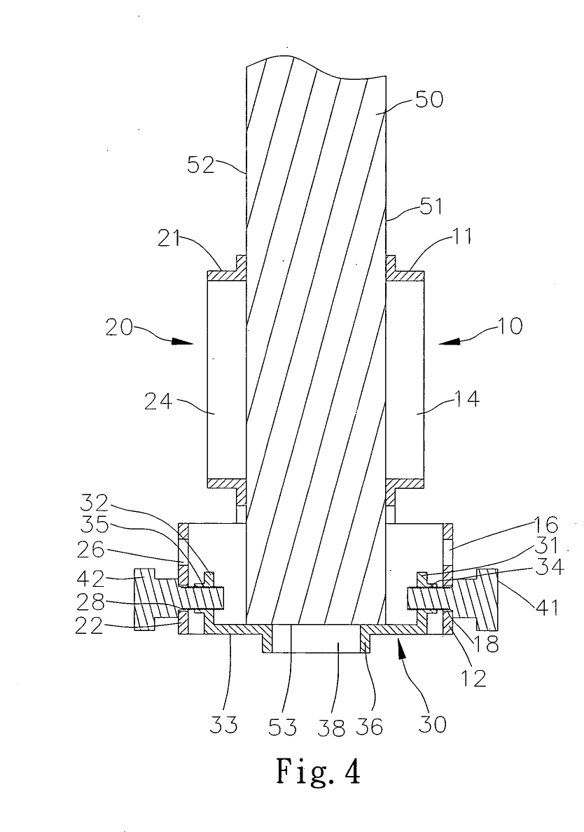

FIG. 4 is similar to FIG. 3 but shows that the first threaded bolt 41 is driven into the threaded hole 34 through the hole 16 and that the second threaded bolt 42 is driven into the threaded hole 35 through the hole 26. Thus, the second hole can be bored in the door 50 at another distance from the side 53.

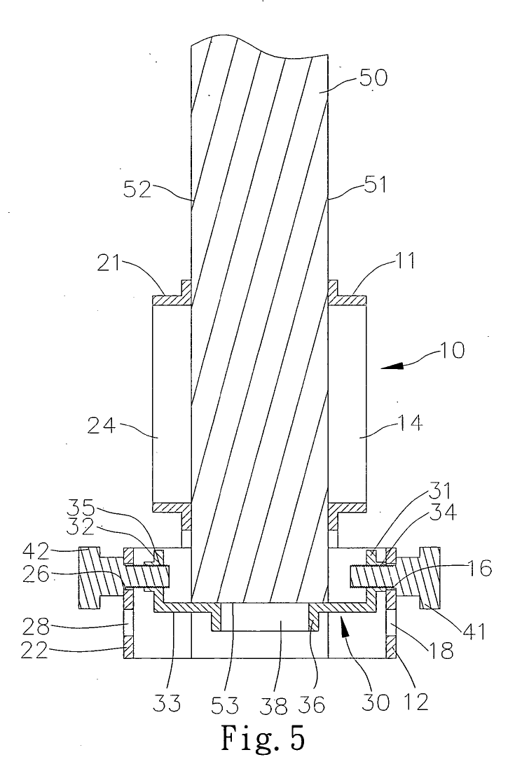

FIG. 5 is similar to FIG. 3 but shows the guide in a different position where the center of the window 38 is not aligned with the middle of the side 53 of the door 50. Accordingly, the center of the second hole is biased from the middle of the side 53 of the door 50.

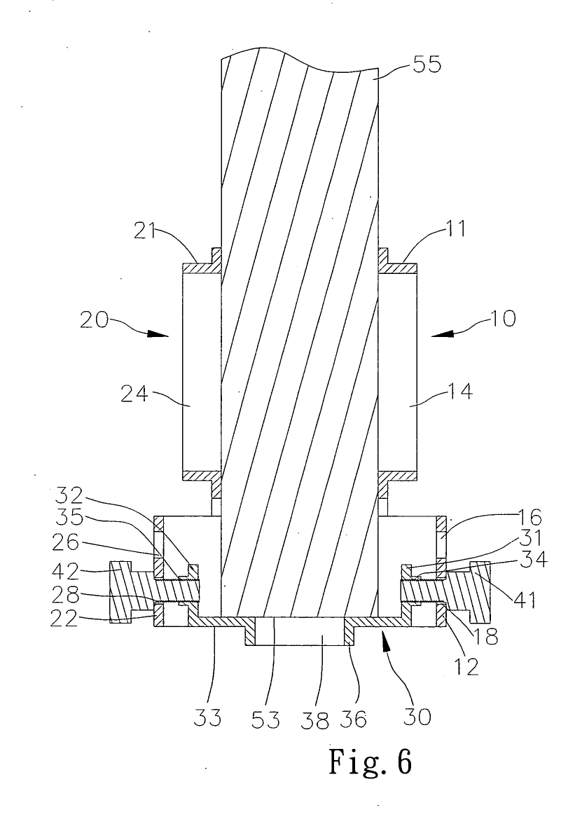

FIG. 6 is similar to FIG. 3 but shows the guide used for a thicker door 55. Thus, the second hole is still aligned with the middle of a side of the door 55.

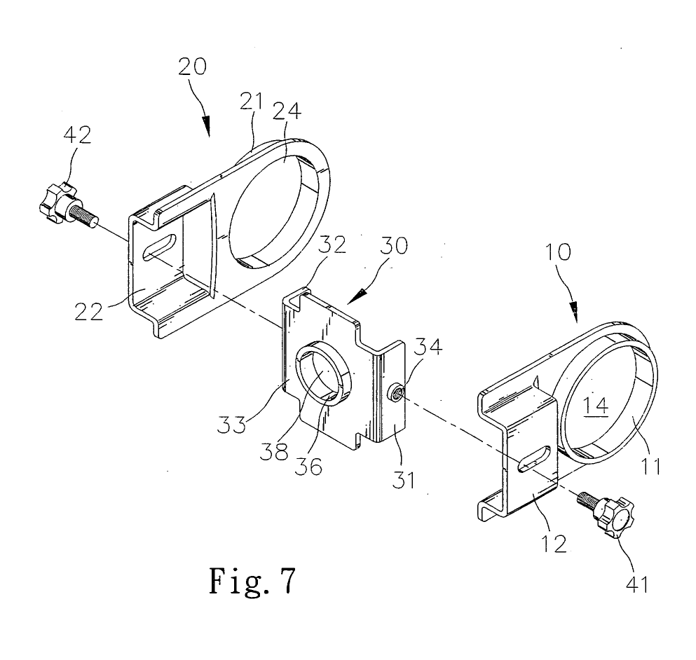

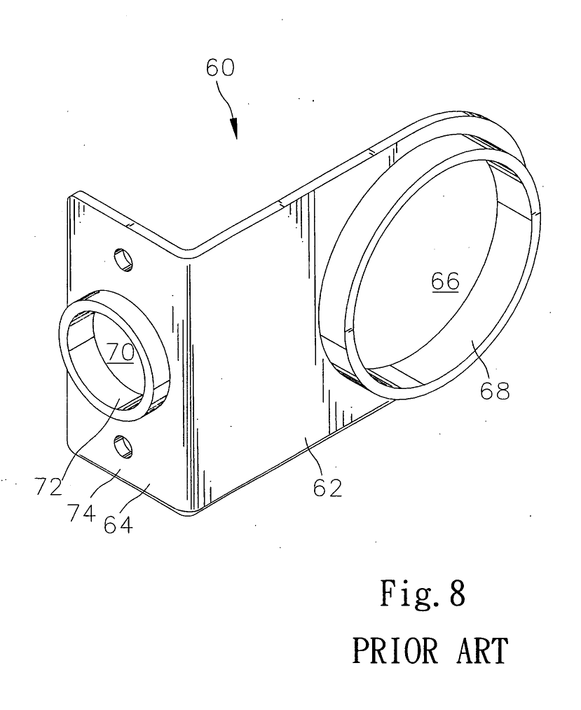

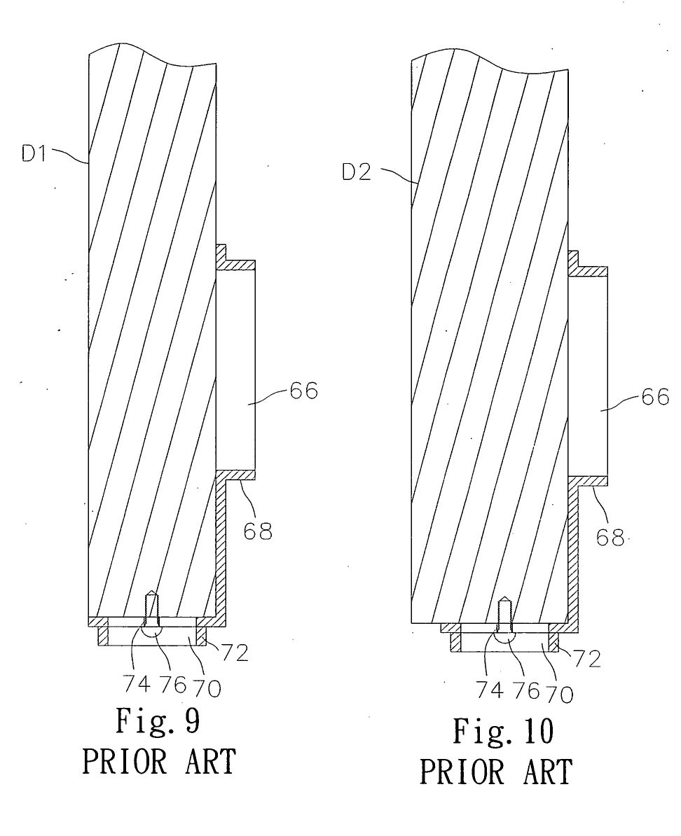

FIG. 7 shows a guide according to a second embodiment of the present invention. The second embodiment is identical to the first embodiment except for substituting a slot 19 for the holes 16 and 18 and substituting a slot 29 for the holes 26 and 28.

The present invention has been described via detailed illustration of two embodiments. Those skilled in the art can derive variations from the embodiments without departing from the scope of the present invention. Therefore, the embodiments shall not limit the scope of the present invention defined in the claims.

1. A guide for guiding a first drill and a second drill while boring a door with holes for receiving a lock, the guide comprising:
a first element for guiding the first drill and abutting a first face of the door;
a second element for guiding the first drill and abutting a second face of the door;
a third element for abutting a side of the door;
a first threaded bolt connected between the first element and the third element so that the first element is movable on the first face of the door, the first threaded bolt being operable for driving the first element against the first face of the door; and
a second threaded bolt being connected between the second element and the third element so that the second element is movable on the second face of the door, the second threaded bolt being operable for driving the second element against the second face of the door.

2. The guide according to claim 1 wherein the first element defines a window for receiving the first drill.

3. The guide according to claim 2 wherein the first element comprises a rim extending around the window for guiding the first drill.

4. The guide according to claim 1 wherein the second element defines a window for receiving the first drill.

5. The guide according to claim 4 wherein the second element comprises a rim extending around the window for guiding the first drill.

6. The guide according to claim 1 wherein the third element defines a window for receiving the second drill.

7. The guide according to claim 6 wherein the third element comprises a rim extending around the window for guiding the second drill.

8. The guide according to claim 1 wherein the center of the window of the third element is movable between an aligned position and a non-aligned position relative to the middle of the side of the door.

9. The guide according to claim 1 wherein the third element comprises a first portion connected with the first threaded bolt, a second portion connected with the second threaded bolt and a third portion formed between the first portion and the second portion.

10. The guide according to claim 9 wherein the third element further includes a threaded hole defined in the first portion thereof for receiving the first threaded bolt.

11. The guide according to claim 10 wherein the first element defines two holes for receiving the first threaded bolt.

12. The guide according to claim 10 wherein the first element defines a slot for receiving the first threaded bolt.

13. The guide according to claim 9 wherein the third element includes a threaded hole defined in the second portion thereof for receiving the second threaded bolt.

14. The guide according to claim 13 wherein the second element defines two holes for receiving the second threaded bolt.

15. The guide according to claim 13 wherein the second element defines a slot for receiving the second threaded bolt.

16. The guide according to claim 1 wherein the third element is sandwiched between first element and the second element.

17. The guide according to claim 16 wherein the first element comprises a bracket for receiving the third element.

18. The guide according to claim 16 wherein the second element comprises a bracket for receiving the third element.
